(19) United States
(12) Patent Application Publication
(10) Pub. No.: US 2018/0107294 A1
(43) Pub. Date: Apr. 19, 2018

(54) MAN-MACHINE INTERFACE HAVING A STEERING WHEEL AND A FINGERPRINT SENSOR ATTACHED THERETO

(71) Applicant: PREH GMBH, Bad Neustadt a. d. Saale (DE)

(72) Inventors: Manuel STOTZEM, Wülfershausen (DE); Andreas KAIL, Bad Neustadt a.d. Saale (DE); Markus KLEIN, Salz (DE)

(73) Assignee: PREH GMBH, Bad Neustadt a. d. Saale (DE)

(21) Appl. No.: 15/730,134

(22) Filed: Oct. 11, 2017

(30) Foreign Application Priority Data
Oct. 18, 2016 (DE) 10 2016 119 846.3

(51) Int. Cl. G06F 3/0354; B62D 1/04; B60R 16/027; G06F 3/038; G06K 9/00

(52) U.S. Cl. CPC G06F 3/03547; B62D 1/046; G06F 2203/0338; G06F 3/038; G06K 9/0002; B60R 16/027

(57) ABSTRACT

The present disclosure relates to a man-machine interface, including a steering wheel rotatably supported about a steering wheel axis and an input device attached to the steering wheel, wherein the input device includes a fingerprint sensor with an acquisition surface for acquiring a fingerprint of a finger of an operator and additionally at least one touch-sensitive and/or operation-sensitive input surface, which is disposed outside the acquisition surface and preferably spaced from the acquisition surface, with an associated detection device, and an evaluation unit connected in an electrically conductive manner with the detection device and the fingerprint sensor, wherein the evaluation unit is configured to verify the data acquired by the fingerprint sensor with a signal of the detection device and, if necessary, to discard them.

This application claims priority to the German Application No. 102016119846.3, filed Oct. 18, 2016, now pending, the contents of which are hereby incorporated by reference.

The present disclosure relates to a man-machine interface with a steering wheel and a fingerprint sensor attached thereto. Fingerprint sensors for personalizing a man-machine interface and methods for the personalization thereof are known. Machines, i.e. the motor vehicle, can be operated by means of a man-machine interface. For this purpose, they may, in particular, have input devices, e.g. in the form of buttons and/or the like. Moreover, a man-machine interface of a motor vehicle usually has a steering wheel by means of which steering inputs for controlling the transverse dynamics of a motor vehicle can be inputted. Further, man-machine interfaces of motor vehicles may have display devices by means of which feedback to operating instructions, operating tips and/or information for a user of the motor vehicle can be provided.

It is known to personalize man-machine interfaces of motor vehicles, so that a configuration and/or an appearance of the man-machine interface are designed differently for different users. DE 10 2005 042 830 A1 relates to an apparatus and a method for setting in a user-specific manner the internal vehicle functions and/or devices, wherein, for at least one user, at least one user-specific data set containing at least one personal user profile of the user can respectively be stored in the memory of an internal vehicle computing unit and/or in a portable memory unit, the user can be identified by means of at least one personal identifier, internal vehicle functions and/or devices can be automatically configured in a user-specific manner by means of the personal user profile, and at least the part of the user-specific data set including the personal user profile can be encrypted, and decrypted only after a successful identification of the user, which is carried out by means of the personal identifier. In particular, a biometric identification of the user is carried out by means of devices suitable for this purpose. The latter have, for example, a scanner for scanning fingerprints. DE 199 41 947 A1 relates to operating members for an instrument cluster and a central display, wherein the operating members are integrated into a steering wheel of the motor vehicle, wherein the operating member for the central display is disposed on the half of the steering wheel facing towards the central display and the operating member for the instrument cluster is disposed on the half of the steering wheel facing towards the instrument cluster.

One drawback of these above-mentioned man-machine interfaces with a steering wheel and a fingerprint sensor attached thereto is that, when the steering wheel is gripped in a manner not directed specifically to the acquisition of the surface of the finger, for example, when the part of the steering wheel provided with the fingerprint sensor is grasped, errors in the acquisition by the fingerprint sensor occur, particularly when it is used for cursor control.

In view of this, there was a need for a solution for a man-machine interface comprising a steering wheel and a fingerprint sensor attached thereto in which erroneous inputs can be avoided more reliably. This object is achieved by a man-machine interface according to claim 1. An equally advantageous use is the subject matter of the independent use claim. Advantageous embodiments are in each case the subject matter of the dependent claims. It must be noted that the features cited individually in the claims can be combined with each other in any technologically meaningful manner and represent other embodiments of the present disclosure. The description, in particular in connection with the figures, additionally characterizes and specifies the present disclosure.

The present disclosure relates to a man-machine interface comprising a steering wheel rotatably supported about a steering wheel axis and an input device attached to the steering wheel. According to the present disclosure, the input device comprises a fingerprint sensor, also referred to as a fingerprint scanner, which defines an acquisition surface for the contact and acquisition of a fingerprint of a finger of an operator. For example, the latter is a fingerprint sensor that is suitable for acquiring a print of the finger, in particular its papillary lines in the case of a stationary finger, at least in some portions. This fingerprint sensor is also referred to as a fully automatic fingerprint sensor. There is a large number of different methods that can be used, according to the present disclosure, for scanning the papillary lines. They include: optical sensors, electrical field sensors, polymer TFT sensors (TFT—thin film transistor), thermal sensors, capacitive sensors, contactless 3D-sensors and ultrasonic sensors.

The hardware component of a biometric system, which at first supplies the biometric measurement data, is referred to as a fingerprint sensor according to the present disclosure as a special form of a biometric sensor. Depending on the biometric method used, various types of sensors may be used according to the present disclosure: The optical sensors use light for acquiring an image of the fingerprint. The electrical field sensor measures the local variation of the electrical field that is produced on the contours of the surface of the finger when a small electrical signal is emitted. The polymer TFT sensor measures the light emitted in the polymer substrate where a contact takes place when the finger is placed thereon. The thermal sensor registers the thermal image of the finger placed thereon. In the capacitive sensor, the sensor surface together with the surface of the finger forms a capacitor whose capacitance changes due to the contour of the skin (ridges and grooves). These local changes are measured and represent the fingerprint. According to the present disclosure, an optical or capacitive fingerprint sensor is preferably used, most preferably a capacitive fingerprint sensor.

The input device additionally comprises at least one touch-sensitive and/or operation-sensitive input surface, which is disposed outside the acquisition surface and preferably spaced from the acquisition surface, and which is associated with a detection device for detecting the touch or operation. For example, a capacitive sensor system for acquiring the touch from an operator in the area of the input surface or a force sensor for measuring the operating force in the case of an operation carried out by the operator in the area of the input surface are provided.

The respective fingerprint sensor used in accordance with the present disclosure is used together with an evaluation unit, i.e. a data processing module, as a so-called on-line system. Since a feedback to the image processing algorithm exists in the on-line method, it is relatively easy to check the quality of the recorded fingerprints immediately.

The fingerprint of a living subject is usually recorded by lightly placing the finger of the operator on the acquisition surface of the fingerprint sensor. In this case, the scan can of course only capture those papillary lines that are in direct contact with the acquisition surface. Therefore, the print of a living subject results in the recording of only a portion of the surface of the finger.

As was explained above, an evaluation unit is also provided which is provided for the evaluation of the biometric data obtained by the fingerprint sensor. It is connected in an electrically conductive manner with, on the one hand, the fingerprint sensor and, on the other hand, with the detection device associated with the input surface. The evaluation unit is further configured to verify the data acquired by the fingerprint sensor, e.g. the biometric data, with a signal of the detection device. For example, the data acquired by the fingerprint sensor, e.g. the biometric data, are discarded in the case of a previous or simultaneous touch on or operation of the input surface, wherein the switching off of the fingerprint sensor is to be considered a discarding in the sense of the present disclosure. Erroneous inputs can thus be avoided and, in particular, inadvertent contacts on the acquisition surface can be recognized as such. On the whole, the operational reliability is increased.

It is preferably provided that the input device is disposed in a steering wheel spoke of the steering wheel.

According to a preferred embodiment of the man-machine interface, it is provided that the input surface, relative to the steering wheel axis, is offset radially outwards in relation to the acquisition surface; in other words, the acquisition surface is disposed closer to the impact absorber than the at least one input surface.

Preferably, several input surfaces are provided. For example, the input surfaces are distributed in a circumferential direction over the associated outer portion of the steering wheel.

According to another variation of the man-machine interface, the at least one input surface and the acquisition surface are disposed on a side of the steering wheel facing towards the operator, i.e. the driver.

According to another variation of the man-machine interface according to the present disclosure, the at least one input surface and the acquisition surface are offset from each other in a direction parallel to the steering wheel axis, i.e. to the rotary axis of the steering wheel.

Preferably, the acquisition surface is recessed relative to the at least one input surface, in a top view onto the respective surrounding steering wheel surface. For instance, the input surface and the acquisition surface are located on the side of the steering wheel facing towards the operator, wherein the input surface is disposed closer to the operator than the acquisition surface. In another embodiment, the input surface and the acquisition surface are located on the side of the steering wheel facing away from the operator, wherein the input surface is disposed further away from the operator than the acquisition surface.

According to another embodiment, the acquisition surface is disposed in a depression of a steering wheel surface.

Preferably, the evaluation unit is configured for running the fingerprint sensor in a scanning mode, in which a fingerprint of an operator is acquired, and in a control mode in order to detect a movement of the finger on the acquisition surface in order to carry out a cursor control. For example, the two modes are selectively selected by the operator and/or the evaluation unit. For example, the control mode is provided for moving a cursor on an electronic display as synchronously as possible with the movement of the finger on the acquisition surface. In one embodiment, it is provided that, in the control mode, the movement is optically detected by means of the speckle interference pattern generated by the fingerprint sensor. Preferably, it is provided that the movement of the finger or of the fingerprint is detected capacitively.

In one embodiment of the man-machine interface according to the present disclosure, an actuator for generating a haptic feedback is additionally provided, wherein the acquisition surface and/or the input surface is caused to move relative to the steering wheel hub by exciting vibrations or an impact in order to provide the operator, via the finger touching the respective surface, with a haptically perceptible feedback if, for example, an acquisition process of the fingerprint was successfully carried out and/or a match between the fingerprint just acquired and previously stored biometric data has been confirmed.

Furthermore, the present disclosure relates to the use of the man-machine interface in one of the above-described embodiments in a motor vehicle.

The present disclosure is explained further with reference to the following figures. The Figures are to be understood only as examples and merely represent a preferred embodiment. In the figures:

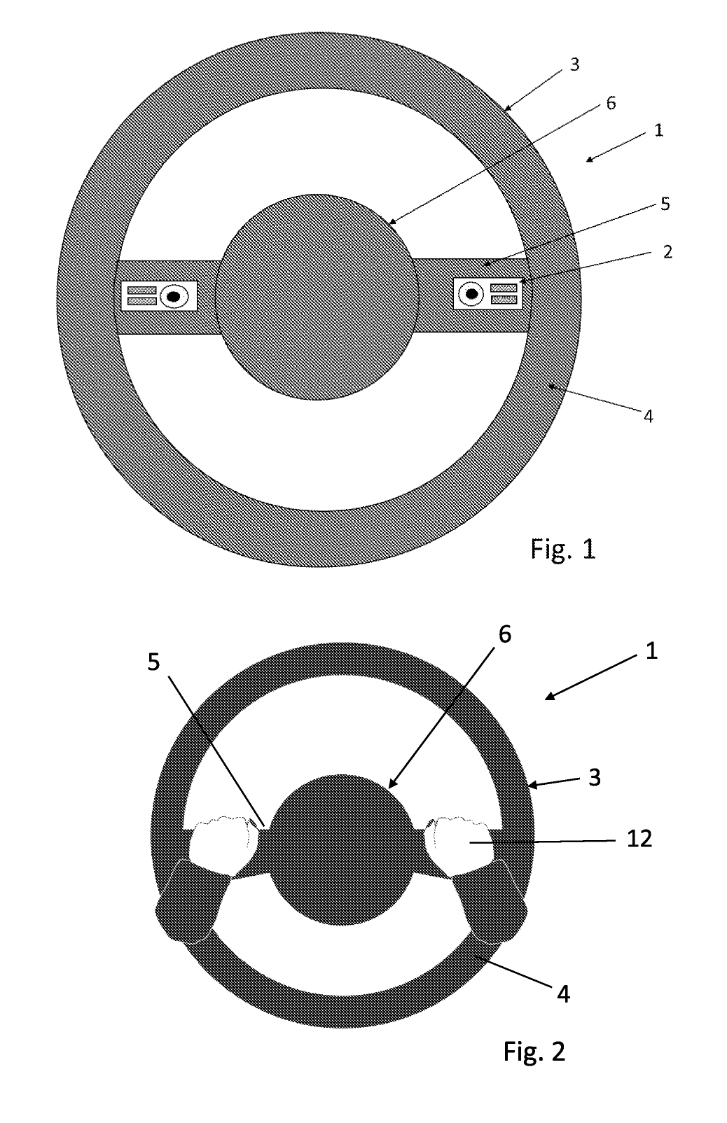

FIG. 1 shows a man-machine interface 1 according to the present disclosure, which comprises an input device 2;

FIG. 2 shows a view of the man-machine interface 1 for illustrating the problem according to the present disclosure;

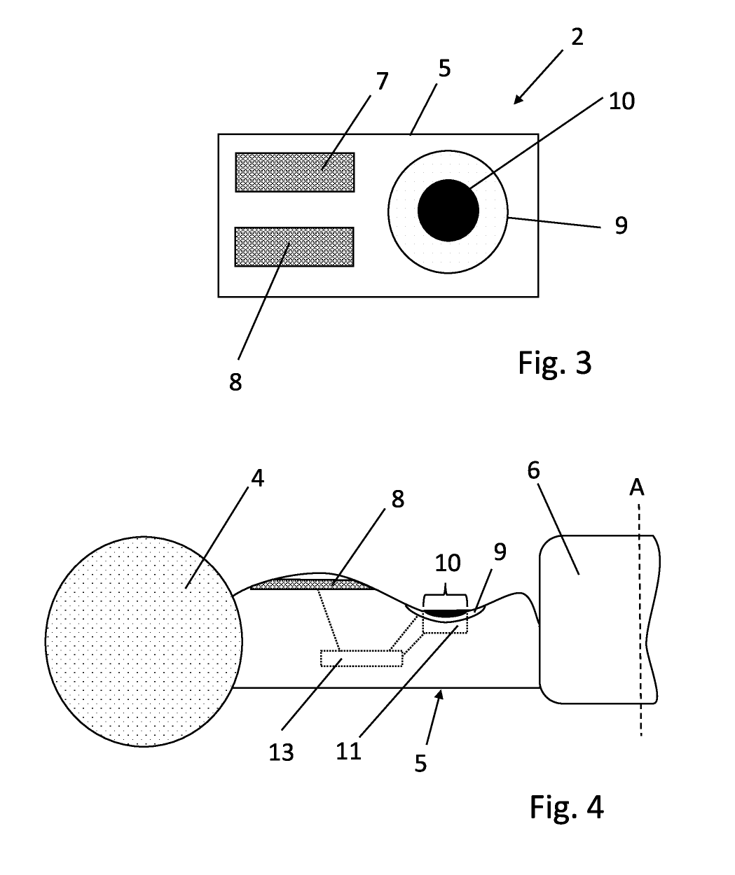

FIG. 3 shows a top view of the input device 2 from FIG. 1;

FIG. 4 shows a side view of the input device 2 from FIG. 1.

FIG. 1 shows a man-machine interface 1 according to the present disclosure in a motor vehicle not shown in detail. The man-machine interface 1 according to the present disclosure has a steering wheel 3 with an outer steering wheel rim 4 and an inner impact absorber 6, which holds the steering wheel rim 4 through two diametrically opposed steering wheel spokes 5. An input device 2, which, among other things, comprises a fingerprint sensor 11, is integrated into each of the steering wheel spokes 5. The input device 2 is shown in a top view in FIG. 3 and in a side view in FIG. 4. The input device 2 has an acquisition surface 10 associated with the fingerprint sensor 11 indicated in FIG. 4. This acquisition surface 10 is surrounded by a first touch-sensitive input surface 9. Several second touch-sensitive input surfaces 7, 8 spaced apart from the acquisition surface 10 are also provided. For example, the distance is less than 5 cm. The acquisition surface 10 is associated with a capacitive fingerprint sensor 11, which in a scanning mode scans the acquisition surface 10 capacitively in order to determine biometric data of a finger resting against the acquisition surface 10 or which, in a control mode, acquires the movement in the case of a sliding movement of the finger across the acquisition surface 10, so that it can be associated with a cursor movement on an electronic display that is not shown, in order thus to control a cursor. FIG. 2 is supposed to illustrate that, if the steering wheel spoke 5 is grasped by the hand 12 of an operator, in this case a driver, the scanning mode cannot be carried out and that unwanted erroneous inputs may occur in the control mode. There is therefore a need to be able to more reliably detect this and similar operating situations, in which inadvertent contacts on the acquisition surface 10 of the fingerprint sensor 11 occur, and to prevent the simultaneous acquisition by the fingerprint sensor 11 by discarding the acquired data. According to the present disclosure, an evaluation unit 13 is provided for this purpose, which is connected in an electrically conductive manner to the fingerprint sensor 11 and to detection devices configured as electrodes for the generation of associated measuring capacitances, wherein the detection devices are each allocated to respectively associated input surfaces 7, 8, 9. The input surfaces 9, 7 and 8, or their detection devices, in the present case, among other things, electrodes for generating associated measuring capacitances, are provided for detecting a touch on the respective input surfaces by means of the evaluation unit 13 in order to verify the data acquired by the fingerprint sensor 11 depending on the result of this detection. In the case of a detection of a touch exclusively on the input surface 9, for example, a correct and intentional operation of the fingerprint sensor 11 via the acquisition surface 10 is presumed, i.e. the data of the fingerprint sensor 11 are positively verified and the fingerprint sensor 11 is run in the scanning mode or in the control mode, whereas in the case of a detection of an additional touch on the input surface 7 or 8, an erroneous operation of the fingerprint sensor 11 is presumed and the respective mode, of the control mode and the scanning mode, is interrupted, or the data acquired in the process are discarded.

For the additional prevention of erroneous operation, on the one hand, and in order to enhance the verification by means of the input surfaces 7, 8, 9, on the other hand, a special relative arrangement of the input surface 7, 8, 9 and the acquisition surface 10 is further proposed in accordance with the present disclosure, of which an exemplary embodiment is shown in FIG. 4. As FIG. 4 shows, the acquisition surface 10 is disposed in a depression of the surface of the steering wheel spoke 5, while the input surfaces 7, 8, of which only the input surface 8 is visible in FIG. 4, are disposed on a raised portion of the surface of the steering wheel spoke 5 facing towards the operator, so that the input surfaces 7 and 8 are offset relative to one another in a direction parallel to the rotary axis A of the steering wheel, resulting in an arrangement of the input surfaces 7, 8 closer to the operator as compared with the acquisition surface 10. As shown in FIG. 4, the input surfaces 7, 8, in relation to a radial direction defined by the steering wheel axis A, are furthermore disposed further outwards than the acquisition surface 10.

1. A man-machine interface comprising:
a steering wheel rotatably supported about a steering wheel axis; and
an input device attached to the steering wheel, wherein the input device further comprises:
a fingerprint sensor with an acquisition surface for acquiring a fingerprint of a finger of an operator; and
at least one of: a touch-sensitive and an operation-sensitive input surface, which is disposed outside the acquisition surface and preferably spaced from the acquisition surface, with an associated detection device; and
an evaluation unit connected in an electrically conductive manner with the detection device and the fingerprint sensor, wherein the evaluation unit is configured to verify the data acquired by the fingerprint sensor with a signal of the detection device and, if necessary, to discard them.

2. The man-machine interface of claim 1, wherein the input device is disposed in a steering wheel spoke of the steering wheel.

3. The man-machine interface of claim 1, wherein the input surface, relative to the steering wheel axis, is offset radially outwards in relation to the acquisition surface.

4. The man-machine interface of claim 1, wherein several input surfaces are provided.

5. The man-machine interface of claim 1, wherein the at least one input surface and the acquisition surface are disposed on a side of the steering wheel facing towards the operator.

6. The man-machine interface of claim 1, wherein the at least one input surface and the acquisition surface are offset from each other in a direction parallel to the steering wheel axis.

7. The man-machine interface of claim 1, wherein the acquisition surface is recessed relative to the at least one input surface.

8. The man-machine interface of claim 1, wherein the acquisition surface is disposed in a depression of a surface of the steering wheel.

9. The man-machine interface of claim 1, wherein the evaluation unit is configured for running the fingerprint sensor in a scanning mode, in which a fingerprint of an operator is acquired, and in a control mode in order to detect a movement of the finger on the acquisition surface in order to carry out a cursor control.

10. A use of the man-machine interface of claim 1 in a motor vehicle.
